(19) United States
(12) Patent Application Publication
(10) Pub. No.: US 2019/0365596 A1
(43) Pub. Date: Dec. 5, 2019

(54) INFLATABLE BALL WITH VIBRATIONAL ELEMENT

(71) Applicants: Erica Conklin, Ankeny, IA (US); Melissa Kahler, Ankeny, IA (US)

(72) Inventors: Erica Conklin, Ankeny, IA (US); Melissa Kahler, Ankeny, IA (US)

(21) Appl. No.: 15/997,983

(22) Filed: Jun. 5, 2018

(51) Int. Cl. A61H 15/00; A61H 23/02

(52) U.S. Cl. CPC A61H 15/00; A61H 23/0263; A61H 2015/0071; A61H 2201/1261; A61H 2015/0042

(57) ABSTRACT

A vibrating element has a generally deformable and/or resilient shell. The deformably resilient shell is utilized to work with the contours of the user to provide conform for use. A vibrational element is associated with the shell and is used to provide dynamic movement in the form of vibrations or pulsing to provide fascial training to a fascia of a user of the vibrating element. Various options and alternatives may be included to provide for different types of dynamic movement, such as timed movement and/or pulsing movement. The resiliency can be provided by an internal structure, such as a fluid within an interior of the shell of the device.

### FIELD OF THE INVENTION

The invention relates generally to the field of health, beauty, anti-aging, and/or wellness. More particularly, but not exclusively, the invention relates to the field of stimulating a part of a body for fitness, exercise, training, and/or treatment.

### BACKGROUND OF THE INVENTION

Fascia (aka “connective tissue”) is the material that runs through our entire body, enveloping our organs and giving us form and structure. It plays a major role in our body, our perception, our mobility, our sense of well-being and in the prevention of injuries. There are many facets to fascia training, and among these can include what may be referred to as fascial release. Fascial release can include the massage of the fascia, such as with massaging devices. The pressure placed on the connective tissue leads to an exchange of fluids in the tissue, whereby lymph and other metabolic products are removed. Fascia loves slow, steady, melting pressure that decreases fascia and muscle tone and can even relieve stiffness and adhesions.

To aid in such fascial training/massaging, devices can be used. Such devices can include static devices, e.g., rollers, balls, or the like, which interact with the fascia. Other devices can be dynamic in nature, wherein the device vibrates, pulses, or otherwise provides an agitation movement to interact with a person's fascia. The dynamic style devices have been shown to provide better treatment and localized massaging of a particular fascial region.

U.S. Patent Publication No. 2017/0106249 is directed towards one such example of a dynamic element in the form of a vibrational ball. U.S. Pat. No. 5,413,551 discloses yet another device in the form of a spherical massage device that includes a vibration element in the interior of a shell.

However, both the '249 publication and the '551 patent include housings that are hard, rigid, or otherwise non-resilient, non-deformable, and/or non-collapsible. They are plastic or other materials that provide a particular shape that is permanent in nature based upon, in part, the rigidity of the material. This rigidity increases the vibrational output to a point that could actually damage a person's fascia, as it is too intense and unforgiving to provide the desired treatment.

Therefore, there is a need in the art for an improved vibrational device that includes a more forgiving housing to provide enough vibration to treat a fascia, while providing resiliency and deformability to form to a use location without damaging the fascia of a user.

### SUMMARY OF THE INVENTION

Therefore, it is a primary object, feature, and/or advantage of the invention to overcome and/or improve on deficiencies in the art.

It is another object, feature, and/or advantage of the invention to provide a dynamic device for fascial training that includes a resiliently deformable outer shell that provides comfort and form to a user's body during use.

It is yet another object, feature, and/or advantage of the invention to incorporate a vibrational element with a generally deformable outer shell to provide movement to a user for fascial training and/or massaging.

It is still another object, feature, and/or advantage of the invention to provide an outer shell with a pocket associated therewith to hold a vibrational element to provide movement to a substantial portion of the outer periphery of the outer shell.

It is a further object, feature, and/or advantage of the invention to provide a variably dynamic device with a deformable housing to treat a user.

These and/or other objects, features, and advantages of the disclosure will be apparent to those skilled in the art. The present invention is not to be limited to or by these objects, features and advantages. No single embodiment need provide each and every object, feature, or advantage.

According to some aspects of the invention, a vibrating fitness device is provided. The device includes a housing including an outer shell comprising a collapsible material and having an internal substance to provide support and shape to the outer shell, wherein the combination of the outer shell and the internal substance is resiliently deformable. The outer shell includes a perimeter. The device also includes a vibrational element associated with the outer shell to provide vibration to a substantial portion of the perimeter of the outer shell to stimulate a portion of a user's body.

The outer shell may be a vinyl, elastomer, or other generally resilient, pliable, elastic, and/or deformable material. The internal substance can be a fluid, such as a gas or a liquid, and may be air. The vibrational element can be an eccentric rotating mass vibration motor, a vibrating plate, a linear resonant actuator, and/or other vibrating element or combination thereof. The vibrational element can be connected to or otherwise associated with a processing unit to provide control thereto, including, but not limited to, on/off, pulsing, communication, feedback, data collection, remote control, timers, levels, or some combination thereof.

According to additional aspects of the invention, a vibrating ball for interacting with a user is provided, and includes an outer shell comprising a resiliently deformable material, the outer shell being substantially hollow, an internal substance within the outer shell to provide a substantially resilient shape of the outer shell, and a vibrational element associated with the outer shell to provide vibration to a substantial portion of a perimeter of the outer shell to stimulate a portion of a user's body.

The outer shell may be a vinyl, elastomer, or other generally resilient, pliable, elastic, and/or deformable material. The internal substance can be a fluid, such as a gas or a liquid, and may be air. The vibrational element can be an eccentric rotating mass vibration motor, a vibrating plate, a linear resonant actuator, and/or other vibrating element or combination thereof. The vibrational element can be connected to or otherwise associated with a processing unit to provide control thereto, including, but not limited to, on/off, pulsing, communication, feedback, data collection, remote control, timers, levels, or some combination thereof.

According to still additional aspects of the invention, a vibrating element for use as a fitness or treatment element for a user is provided, which includes a ball comprising an outer shell comprising a resiliently deformable material, the outer shell being substantially hollow, and an internal substance within the outer shell to provide a substantially resilient shape of the outer shell; a vibrational element associated with the outer shell to provide vibration to a substantial portion of a perimeter of the outer shell to stimulate a portion of a user's body; and a processing unit operatively connected to the vibrational element to provide operational instructions to the vibrational element.

The outer shell may be a vinyl, elastomer, or other generally resilient, pliable, elastic, and/or deformable material. The internal substance can be a fluid, such as a gas or a liquid, and may be air. The vibrational element can be an eccentric rotating mass vibration motor, a vibrating plate, a linear resonant actuator, and/or other vibrating element or combination thereof. The vibrational element can be connected to or otherwise associated with a processing unit to provide control thereto, including, but not limited to, on/off, pulsing, communication, feedback, data collection, remote control, timers, levels, or some combination thereof.

### BRIEF DESCRIPTION OF THE DRAWINGS

FIG. 1 is a perspective view of an exemplary vibrating device for fascia training according to aspects of the invention.

FIG. 2 is cross section view of an exemplary vibrating device for fascia training according to aspects of the invention.

FIG. 3 is a depiction of the use of a vibrating device according to aspects of the invention by a user.

FIG. 4 is a diagram showing components of an exemplary vibrating device according to aspects of the invention.

Various embodiments of a seed delivery system and related components are described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENTS

Aspects of the invention are directed towards an element for use in treating, training, and/or massaging a fascia of a user. As is known, the fascia is connective tissue that runs through our bodies, enveloping our organs and giving us form and structure. The fascia can play a major role in the health of an individual, including mobility, training, prevention of injuries, positive impact on the lymphatic and nervous system, anti-aging, hydration, and/or core strength. However, this should not be considered limiting, as there are numerous untold benefits to having a strong fascia. Therefore, it is important to train the fascia. The term, fascia training, can take on more meanings than traditional training. For example, it is not solely to mean weights, cardio, and/or the like that are utilized to build and or strengthen a fascia, although those types of exercises may be part of a regimen. Other types and facets of fascia training can include fascial release. The fascial release can include massaging of the fascia such as with massaging elements. Traditionally, as is known, elements such as balls, rollers, and the like can be utilized to interact with the fascia to train the same. However, it has been found that the addition of vibrational and/or other dynamic movements to a massaging element can provide even greater benefits and improvements in fascial training. Therefore, aspects of the invention include a dynamic element for use with fascial training.

As will be understood, the dynamic ability of the invention provides for improved training of the fascia. In addition, the element will be resilient, deformable, collapsible, and/or some combination thereof to provide for a controlled interaction between the dynamic device and a user. The deformability and resiliency of the element according to aspects of the invention will allows the device to form with the contours of the user, while still providing some support to impart a vibrational and/or pulsing movement to the user, which is part of the fascia training. The deformability and resiliency of the element is a major step and improvement over that known in the art. For example, it has been known to utilize substantially rigid housing members to impart the vibrational movement to a user. However, such rigid elements can be damaging and/or uncomfortable to a user and also can provide too much vibrational movement to the fascia, which can cause more harm than good.

In addition, while aspects of the invention, as will be understood, include the use of a generally spherical or ball shaped element, it is to be appreciated that other shapes can be included and/or contemplated by the invention, and the deformability and resiliency of the housing of such variation and shape will provide even greater variability and usability to a user. Therefore, while a ball or spherical shape may be shown and described, it is to be appreciated that generally any shape that is used in fascial training and/or massaging elements can include the aspects of the invention as disclosed herein.

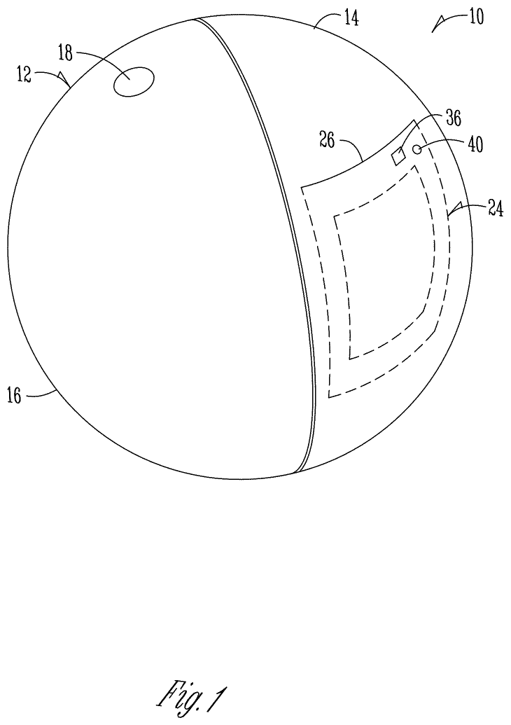

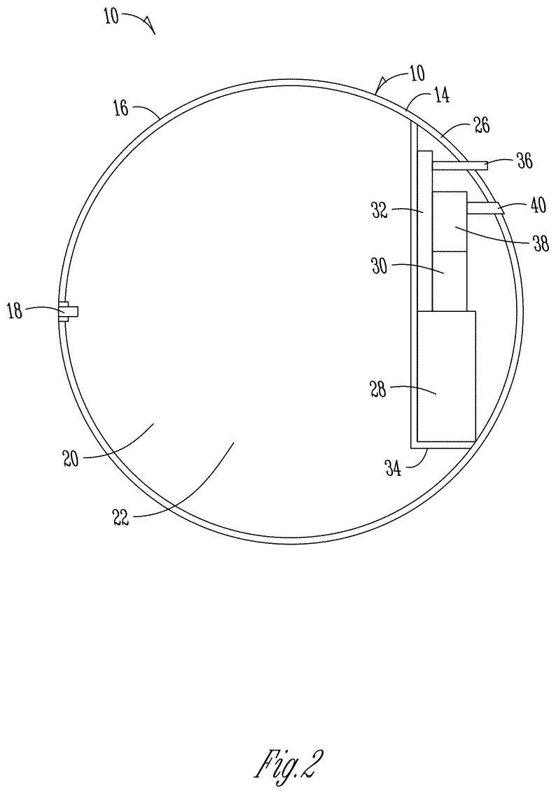

FIGS. 1 and 2 shows exemplary embodiments of a vibrating ball 10. The vibrating ball is an element with a housing 12 and a vibrational element 28 associated with the housing 12 in order to impart a vibrational movement to substantially all of or at least a substantial portion of the housing 12. This vibrational movement will then be imparted to a user upon interaction with the ball 10. The size of the ball is generally immaterial for purposes of the present invention, and it is to be understood that the invention includes variations to the size and overall shape of the ball 10. As will be understood, such variations in size and shape will allow for use of the vibrating device with different portions of a user's body.

As disclosed, the ball 10 comprises a housing 12. The housing 12 may include an outer shell 14 having a particular perimeter and/or shape 16. The perimeter 16 of the shell 14 as shown in FIGS. 1 and 2 is generally spherical and/or ball shaped. The shell 14 comprises a generally resilient, pliable, deformable, and/or elastic type material. For example, according to some aspects of the invention, the shell may comprise a resiliently deformable material in which a form can be given to the shell 14, while allowing for some deformability to allow the ball to form with the contours of the user or a portion of a user. However, upon release and/or movement away from user, the shell and structure providing support to the shell can be such that a ball will be resiliently reformed into its ball shape. This deformability which may also be referred to as collapsibility, provides numerous advantages for being able to be used with users of different size, shape, and as well as different portions of a user's body.

For example, it is contemplated that the shell comprising material which is generally resilient, elastic and/or deformable. Such a material may comprise Ledraplastic which is a type of rotational molded nontoxic vinyl. In addition, other types of vinyl may be contemplated to be used as a shell 14. In addition, it is contemplated that the shell comprised in an elastomer, such as rubber or a type of rubber to provide for the resiliency of the shell and used with an internal structure, such as a fluid. In addition, the shell may take the form of other materials, which may have characteristics of elasticity, resiliency, pliability, deformability, and/or some combination thereof. The exact composition of the shell is not to be limited to a particular material or material type.

Furthermore, according to at least some aspects of the invention, the interior 20 of the shell 14 is substantially hollow. This allows for an internal substance 22, which may also be referred to as a support structure, to be included to provide the general shape and/or sustained perimeter 16 of the shell 14. According to some aspects of the invention, the internal substance 22 within the interior 20 of the shell 14 is a fluid, such as a gas or a liquid. The gas and/or liquid will provide support to the shell to maintain its shape, and also to provide some deformability and resiliency to the shape and/or perimeter of the shell 14.

The internal substance, which has been disclosed to be a fluid, may also include some structure, such as a foam, spring, or other structure that allows for some deformability while also providing resiliency to the shell 14 of the ball 10. A fluid, such as a gas or a liquid will provide a shape 16 to the shell 14, which can be defined, at least in part, by the material composition of the shell 14. For example, vinyl materials may have less elasticity than some elastomers, but may provide for greater stability than some elastomers. However, additional types of elastomers, vinyl materials, plastics, and the like may be utilized to achieve the desired amount of resiliency, elasticity, deformability, or some combination thereof. When a fluid, such as a gas or a liquid is utilized in the internal portion of the shell 14, a plug or valve 18 can be utilized to allow access thereto and to also prevent escape of the gas and/or liquid from the internal cavity of the shell 14. The plug can be friction fit, threaded, gasket, or otherwise provided to allow the fluid to be added the interior 20 of the shell 14, while preventing or else mitigating the release of said fluid therefrom.

The plug could be a stopper plug that is placed to prevent or mitigate the release of the internal fluid. The plug 18 could also be an inflation valve, that could be accessed orally or with a pump to add fluid to the interior of the shell. This allows for filling/refilling of the interior substance, and also deflating. Still other types of valves and/or plugs may be utilized.

As disclosed, the interior 20 of the shell 14 may be filled with a fluid, such as a gas or a liquid. Gasses can include something as simple as air. The air will allow for a structure and shape to be provided to the shell 14 while also allowing for some give and deformability of shell 14 when a pressure is applied thereto. Air is also compressible. Furthermore, water or other liquids could also be included in the interior and utilized as the internal substance 22. The water or other liquid could also provide for the structural support to provide a shape 16 of the shell 14, while allowing for the movement therein to allow for the deformability of the shell 14 upon a pressure being applied thereto. Still other types of internal structures including other types of gasses and/or liquids, as well as combinations thereof, could be contemplated to be included in the interior 20 of the shell 14 such that it will provide a general shape at the perimeter 16 of the shell 14 while also allowing for some deformability to the shape of the shell 14 while allowing for a resilient nature of the shell to revert back to its shape, such as a ball shape.

In addition, a vibrational element 28 is included and associated with the shell 14 of the vibrating ball 10 to impart a vibrational and/or dynamic movement to the shell 14. As disclosed, such a vibrational movement provides numerous advantages and fascial training. Such vibration will aid in the massage of the fascia, which will release fluids in the connective tissue unwanted products are removed. This pressure decreases fascia and muscle tone and can release thickness and adhesions in the body. The vibrational element 28 is associated with the shell 14 in such a manner that the vibrational element will provide a movement to a substantial portion of or substantially the entire periphery of the shell 14. An exemplary way to provide such a movement to the periphery of the shell 14 is disclosed in FIG. 2, which is a cross sectional view of an exemplary ball 10 according to aspects of the invention. As shown in FIG. 2, a pocket 24 is formed at or near the perimeter 16 of the shell 14. For example, the pocket 24 may be formed along an arc or a portion of an arc of the perimeter 16 of the shell 14. The pocket can include an opening 26 which allows for access to inside the pocket 24, and can be closed on its three sides to provide for support and imparting movement of the vibrational element 28 to the perimeter 16 of the shell 14. However, it should also be appreciated that other forms of pockets, along with varying orientations of the pockets with respect to the shape of the shell 14 are to be considered part of the invention.

As shown in FIG. 2, the vibrational element 28 is positioned generally within the pocket 24 of the shell 14. The exact type of vibration element is not to be limiting on the invention, and is contemplated that generally any type of vibrating motor can be utilized to impart the dynamic movement to the shell 14 itself. For example, types of vibrational motors which can be included as part of the invention can include an eccentric rotating mass vibration motor or a linear resonant actuator. An eccentric rotating mass vibration motor uses a small unbalanced mass on a DC motor (possibly a brushless DC motor), and when it rotates it creates a force that translates to vibrations. A linear resonant actuator contains a small internal mass attached to a spring, which creates a force when driven. These are the basic types of vibrating motors, and therefore are contemplated to be utilized with the invention as disclosed. It is to be noted that neither specific type of motor is required to be used, and generally any type of motor can be used and can be changed depending on the amount of movement desired for a particular vibrating ball 10. For example, small vibration motors can be used with smaller perimeter shells 14, in which a reduced amount of vibration is required to impart movement to the periphery of the shell 14. However, with larger perimeter devices, a large motor may be desired to provide greater vibration or to impart vibration to the entire or substantially entire periphery of the larger device. Still, further it is contemplated that multiple vibrational elements and/or motors be utilized with a single vibrating ball 10. For example, multiple pockets, such as on opposite hemispheres or on opposite portions or on multiple portions about the perimeter of the shell 12 can be utilized to provide vibrational movement at multiple locations thereof. The multiple vibrational elements creating multiple vibrational forces can be tuned such that the concurrent vibrations will work together to provide a dynamic movement for substantial area and/or size of the ball 10. In addition, there are times when different vibrational outputs are desired, such as different pulses or different wavelengths of vibration. Therefore, the different vibrational motors will be able to be used to provide for such variation and vibrational output. However, examples of vibration motors can take many forms and can include pager type motors, pancake or coin type motors encapsulated and/or otherwise provided. These can include feedback type vibrational, etc.

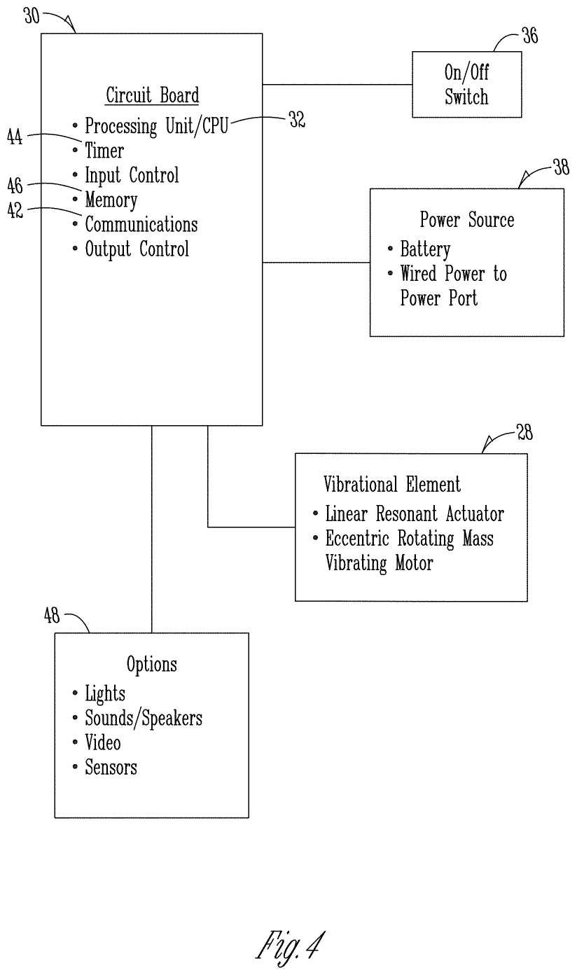

Additional features associated with the vibrating ball 10 according to aspects of the invention may include a circuit board 30 for use in controlling aspects of the vibrational element 28. FIG. 4 discloses a diagram including aspects related to the control of the vibrational element 28 according to some aspects of the invention. For example, the figure includes the use of a circuit board 30. Associated with the circuit board 30 can be processing unit (e.g., a microprocessor, a microcontroller, or another suitable programmable device) or otherwise known as an intelligent control 32. The circuit board also can include other components and can be implemented partially or entirely on a semiconductor (e.g., a field-programmable gate array (“FPGA”)) chip, such as a chip developed through a register transfer level (“RTL”) design process. The processing unit, which is also referred to as a central processing unit or intelligent control can be used to provide instructions and to receive signals from various members or portions of the circuit board, vibrational element, power, switch, and/or other options to vary the output or some other function of the vibrating ball 10. The circuit board can be positioned within a casing and include the vibrational element 28 on the circuit board or otherwise operatively attached thereto, such as by wire. A power source, which may be a wired or wireless power source can be associated with a circuit board and a vibrational element provide power thereto. An on/off switch can be located on the ball 10 and operatively connected to the circuit board to turn the vibrational element on or off. As will be understood, additional elements may be included which will negate the need for a physical on/off switch associated with the circuit board of the ball itself.

As disclosed, the circuit board can include a processing until which can also be connected to various other mechanisms to provide for varying output of the vibrating ball 10. For example, the timer 44 can be connected to the processing unit 32 to provide for a timed timer function in which the vibrational element 28 will be operated for and allotted amount of time. The timer 44 can be connected to the on/off switch 36 to being and end the vibrational element 28 by turning on or off the vibrational element based on the set amount of time for operation. Input controls can be included with the circuit board and connected with the processing unit as well. Such input controls can vary the operation of the vibrational element 28 of the vibrating ball 10. For example, the input control can change the level of vibration, such as by increasing or decreasing the intensity of the vibration based on a user's requested amount of movement. The input control can also apply variability to the type of vibration, such as by varying the pulsing and/or wavelengths of the vibrations and/or the lengths of the vibrations no vibration in between to provide for additional and variable types of vibrating for the ball 10.

Still further, a memory could be associated with a processing unit. The memory includes, in some embodiments, a program storage area and a data storage area. The program storage area and the data storage area can include combinations of different types of memory, such as read-only memory (“ROM”), random access memory (“RAM”) (e.g., dynamic RAM (“DRAM”), synchronous DRAM (“SDRAM”), etc.), electrically erasable programmable read-only memory (“EEPROM”), flash memory, a hard disk, an SD card, or other suitable magnetic, optical, physical, or electronic memory devices. In some embodiments, the processing unit is connected to the memory and executes software instructions that are capable of being stored in a RAM of the memory (e.g., during execution), a ROM of the memory (e.g., on a generally permanent basis), or another non-transitory computer readable medium such as another memory or a disc. Software included in the illustrated implementation of the vibrating ball can be stored in the memory of the circuit board and/or processing unit. The software includes, for example, firmware, one or more applications, program data, filters, rules, one or more program modules, and other executable instructions. The memory can store instructions, such that preset instructions can be included and/or learned by the memory of the processing unit. The memory 46 can be programmed to provide such instructions and the ball can recall said instructions from the memory 44 to automatically in a desired or set manner. For example, the memory can include instructions with varying types of vibrations and times of vibration. The memory could have programs set based on regular use of the ball and regular treatment of portion of a user's body and/or a user's fascia. For example, a back function could be set, and the memory would recall instructions with a back of a body in order to provide for a preset intensity and/or timer function to provide a programmed use of the ball for a user such that a user does not have to keep track and/or set the intensity of the vibration of the ball.

Furthermore, communications may be included with the processing unit. The communications element 42 can provide for a wired or wireless interaction with a remote device separate than the ball to allow for a programming, instructions, change, on/off, or otherwise manipulation of the operation of the ball 10 without having to physically interact with the ball 10. For example, the communication can include a network, Wi-Fi, Bluetooth, near field communication, CDMA, or the like to be in communication with a remote device, such as an application on a tablet, smartphone, computing device or dedicated remote for the ball 10. The network can be a local area network (“LAN”), a neighborhood area network (“NAN”), a home area network (“HAN”), or personal area network (“PAN”) employing any of a variety of communications protocols, such as Wi-Fi, Bluetooth, ZigBee, near field communication (“NFC”), etc., although other types of networks are possible and are contemplated herein. Communications through the network by a communications module or the processor can be protected using one or more encryption techniques, such as those techniques provided in the IEEE 802.1 standard for port-based network security, pre-shared key, Extensible Authentication Protocol (“EAP”), Wired Equivalency Privacy (“WEP”), Temporal Key Integrity Protocol (“TKIP”), Wi-Fi Protected Access (“WPA”), and the like.

A remote device could communicate with the circuit board 30 to provide instructions thereto and to affect the operation thereof. The remote device can take the form of any portable communications device adapted to both receive data from a user and communicate that data to the communications module. Such instructions could related to turning on or off the vibrational element, could affect the intensity or duration of the vibrational elements, or could vary the vibration elements such as pulsing the elements. The remote communication of the remote device will allow a user or a third party to provide changes to the vibrational elements of the ball 10 without requiring a user to move or otherwise become disassociated with the vibrating ball 10. Furthermore, an output control can be provided in which the output control works in tandem with the memory to track data associated with the use of the vibrating ball 10. For example such use may include the duration of use, intensity of use, how often a ball is used, and/or other information that could be stored in memory and communicated in view of the output control to the remote device, such as a computer, tablet, telephone, PDA, or dedicated remote which the data associated with the use of the ball could be transmitted for determination if the use of the ball is helpful and/or if there needs to be changes made to the use of the ball to aid in the fascial training thereby.

As mentioned, an on/off switch is associated with the circuit board to provide for turning on and off the vibrational element thereof. The on/off switch can be a physical switch on the ball, or could be a remotely accessed soft key, such as on a remote device in communication with a circuit board with a ball 10.

A power source is associated with the circuit board to provide power thereto, including to the vibrational element 28. It is contemplated that the power source could be a wire or wireless source. It is contemplated that the system be hard-wired, cord and plug connected, or otherwise powered, such as to AC power plugs and sockets. The hard-wired power source could be on a power grid, or could be a separate generator, battery, or other source. The wire could provide power over Ethernet or via USB cable, such as if the system is connected in such a manner. Still further, it is contemplated that the system be self-powered or include on-board power, in that there is no wiring to a separate power source. Such a configuration could include batteries in the system, such as non-rechargeable (e.g., dry battery) or rechargeable (e.g., Lithium-ion) type batteries. Still further, other types of power, such as, but not limited to, solar, piezoelectric sources, and the like, which can provide additional amounts of power.

For example, a wireless battery source could be in the form of a battery or a battery pack. It is contemplated that the use of the term battery could include the use of a single or multiple batteries in conjunction with the circuit board. The battery and/or battery pack can take the form of a rechargeable battery, such as a lithium ion battery pack which can be recharged via a power port to mitigate the need to replace the batter and/or battery pack with the use of the ball is maintained. However, the casing 34 associated with the circuit board 30 can also include a housing 4 replaceable battery, which can be replaced when needed. Furthermore, it is contemplated that a wire power can be utilized to power the circuit board and vibrational element of the vibrating ball 10. A wire powered can be an auxiliary cord, such as via a power port and in communication with the circuit board 30 to provide power thereto. The wired power could be utilized such as when it is unwanted to have to have to replace batteries.

Further options to be contemplated to be included with the circuit board 30, which are not required but can include additional elements to improve the use and functionality of the ball 10. Such options can be used in combination with one another or can be singularly used or groups of them can be used with a ball 10. For example, lights can be associated and in communication with the circuit board to provide for feedback for using the ball 10. The lights could provide write messages, could provide timing functions, could provide notice of use, or could provide other features in which an optical feedback may be desirable. Such lights could be placed at or near a pocket, or could be spaced about the periphery to provide for notification and/or feedback regardless of the placement of the pocket 24.

Additional options could be oral features, such as speakers or other sound making devices. Such speaker systems could be incorporated with the circuit board 30 and could provide additional feedback to a user. For example, the sounds could provide instructions for using the ball, could provide timing features, could provide updates on use of the ball, could provide reminders, or could provide alarm features to alert a user such as when a timer is almost finished, when a battery is almost dead, or when it is time to move the vibrating ball element 10 to another location on the body. Still further the speakers could provide additional feedback and could be connected to the communications element 42 of the circuit board in which a remote operator could provide, in real time, communications via the speaker to a user, such as how to use the ball or how to troubleshoot features with the ball 10. The speakers could also be included to a Bluetooth element in such a manner that a remote device could communicate sound such as sounds, or music or other sounds through the speakers via the remote device. This could provide soothing, or otherwise entertainment to a user of the ball 10.

A video element could be associated with the ball, such as on an external portion of the pocket 24. Such a video element could include an analog or digital display in which a timer function could be included, a status indicator could be included, instructional elements could be included, or other information could be provided at or near the video or screen of the ball 10 to provide some information to a user or a party thereof. For example, the video element can include a display (e.g., a primary display, a secondary display, etc.) and input devices (e.g., touch-screen displays, a plurality of knobs, dials, switches, buttons, etc.). More specifically, the display can be, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, or a reflective bistable cholesteric display (i.e., e-paper).

Still further sensors could be included as an option for use in communication with the circuit board. Such sensors could provide indication of the amount of the internal substance 22 and the interior 20 of the shell 14, could provide information related to the amount of force applied to the ball, or could provide other sensing information that may be useful to fascial training.

It is contemplated that the ball include may different variations and/or elements associated with to provide fascial training and feedback therewith. As indicated, such elements and options need not be required on all aspects of the invention, and various combinations of the same be included to provide for different features and/or uses of the ball 10.

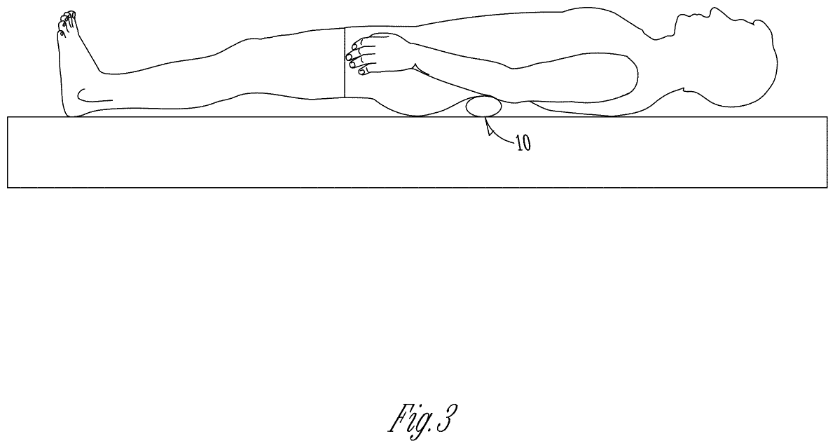

As noted herein, the ball is utilized for fascial training and is used by a user to treat a location on their body. FIG. 3 is an exemplary picture showing the uses of a ball 10 according to aspects of the invention by a user as part of their fascial training. As shown in FIG. 3, a ball can be positioned against a user's body, such as any portion of the body. Activation of the ball 10 will begin the dynamic movement of the shell 14 or at the periphery of the shell 14 to interact with the fascia of the user. Such vibrational movement will aid in the fascial training thereof. Furthermore, the ball can be positioned between the user and a solid surface, such as a floor or a wall. The deformability and resiliency of the shell 14 will allow for the shell to collapse when the user imparts a force against a ball and the solid surface, wherein the deformability will not greatly affect the dynamic of the shell so as to still provide the desired training and or massaging to the user. Upon movement from the user from the ball, the resiliency thereof will allow the ball to revert to its original shape, in this case a ball shape.

In addition, as disclosed herein, the inflatable member can take many different shapes, forms, and sizes. For example, a certain size may be best used with certain body parts, such as back or thigh portion of a user. However, it is contemplated that a small version of a vibrational element be utilized with other features of a user, such as in a fascial region. Smaller features could be used with hands and/or feet, as well as the face or sensitive areas of the body. Therefore, it is contemplated that the invention need not be limited to the ball shaped and or sized as indicated herein, and it is contemplated that variations in the size and shape be included as part of the invention.

Therefore, a generally resilient and/or deformable element with a vibrational component has been shown and described. Such a deformable, resilient, and dynamic element can be utilized with fascial training to provide interaction with a user's fascia in order to treat and/or train the fascia, as part of a person's fitness regimen. This could also be beneficial and provide benefits and/or use in terms of health, beauty, anti-aging, or the like. The vibrational element can be associated with a perimeter of the device to impart a vibrational and/or dynamic movement to a substantial periphery of the device, which can then be a part of the user. The deformability and resiliency of the shell of the device will allow for greater comfort and control of the vibration imparted on the user, and for forming the element to the contours of the use. It is to be contemplated that variations to the disclosed and that may be obvious to those skilled in the art are to be considered part of the present disclosure. Furthermore, it is contemplated that exemplary embodiments have been shown and described herein, and it is to be appreciated that aspects of the individual embodiments may be combined with one another in ways not explicitly shown and described for advantages of the invention.

What is claimed is:

1. A vibrating fitness device, comprising:
a housing including an outer shell comprising a collapsible material and having an internal substance to provide support and shape to the outer shell, wherein the combination of the outer shell and the internal substance is resiliently deformable;
wherein the outer shell includes a perimeter; and
a vibrational element associated with the outer shell to provide vibration to a substantial portion of the perimeter of the outer shell to stimulate a portion of a user's body.

2. The vibrating fitness device of claim 1, wherein the housing is ball-shaped.

3. The vibrating fitness device of claim 1, wherein the internal substance is a fluid.

4. The vibrating fitness device of claim 3, wherein the fluid comprises:
a. a gas;
b. a liquid; or
c. a combination of gas and liquid.

5. The vibrating fitness device of claim 4, further comprising a plug through a portion of the outer shell.

6. The vibrating fitness device of claim 1, wherein the outer shell comprises vinyl.

7. The vibrating fitness device of claim 1, wherein the housing further comprises a pocket operatively connected to the outer shell, and wherein the vibrational element is positioned at least partially in the pocket.

8. The vibrating fitness device of claim 7, wherein said pocket extends generally along an arc of the outer shell.

9. The vibrating fitness device of claim 1, wherein the vibrational element comprises an eccentric rotating mass vibration motor.

10. The vibrating fitness device of claim 1, wherein the vibrational element comprises a linear resonant actuator.

11. A vibrating ball for interacting with a user, the vibrating ball comprising:
an outer shell comprising a resiliently deformable material, the outer shell being substantially hollow;
an internal substance within the outer shell to provide a substantially resilient shape of the outer shell; and
a vibrational element associated with the outer shell to provide vibration to a substantial portion of a perimeter of the outer shell to stimulate a portion of a user's body.

12. The vibrating ball of claim 11, wherein the outer shell comprises a vinyl.

13. The vibrating ball of claim 11, wherein the outer shell comprises an elastomer.

14. The vibrating ball of claim 11, wherein the internal substance is a fluid.

15. The vibrating ball of claim 14, wherein the fluid comprises:
a. a gas;
b. a liquid; or
c. a combination of gas and liquid.

16. The vibrating ball of claim 11, wherein the housing further comprises a pocket operatively connected to the outer shell, and wherein the vibrational element is positioned at least partially in the pocket.

17. The vibrating ball of claim 11, further comprising a processing unit operatively connected to the vibrational element to provide operational instructions to the vibrational element.

18. A vibrating element for use as a fitness or treatment element for a user, comprising:
a ball comprising an outer shell comprising a resiliently deformable material, the outer shell being substantially hollow, and an internal substance within the outer shell to provide a substantially resilient shape of the outer shell;
a vibrational element associated with the outer shell to provide vibration to a substantial portion of a perimeter of the outer shell to stimulate a portion of a user's body; and
a processing unit operatively connected to the vibrational element to provide operational instructions to the vibrational element.

19. The vibrating element of claim 18, further comprising a power source operatively connected to the processing unit and the vibrational element.

20. The vibrating element of claim 18, wherein the operational instructions comprise:
a. on and/or off;
b. different levels of vibration;
c. different vibrational pulsing;
d. timed operation;
e. data output of use of the element;
f. remote communication with remote input device; or
g. some combination of a.-f.
